(19) United States
(12) Patent Application Publication
(10) Pub. No.: US 2026/0208769 A1
(43) Pub. Date: Jul. 23, 2026

(54) AN AUTOMATED STORAGE AND RETRIEVAL SYSTEM WITH LOGICALLY OPERABLE BARRIERS FOR SAFE ENTER AND EXIT INTO A TRANSPORT VEHICLE, AND AN ASSOCIATED METHOD

(71) Applicant: AutoStore Technology AS, Nedre Vats (NO)

(72) Inventors: Jørgen Djuve Heggebø, Langhus (NO); Geir Vikingstad, Haugesund (NO); Kenneth Müller, Vormedal (NO)

(21) Appl. No.: 19/137,203

(22) PCT Filed: Dec. 6, 2023
(86) PCT No.: PCT/EP2023/084616

§ 371 Date: Jun. 9, 2025

(30) Foreign Application Priority Data
Dec. 16, 2022 (NO) 20221350

(51) Int. Cl. B61B 1/02; B61B 5/02; B61C 13/04; B61F 5/50; B61L 25/02; B65G 1/04

(52) U.S. Cl. CPC B61B 1/02; B61B 5/02; B61C 13/04; B61F 5/50; B61L 25/025; B65G 1/0464; B65G 2207/40

(57) ABSTRACT

It is described an automated storage and retrieval system (1) comprising: a rail system (108) comprising a first set of parallel rails (110) extending in a first direction (X) across the top of a frame structure (100) formed by a plurality of upright members (102), and a second set of parallel rails (111) in the horizontal plane arranged in a second direction (Y) perpendicular to the first set of parallel rails (110), to guide movement of container handling vehicles (201; 301; 401) in the first direction (X) and the second direction (Y), and wherein the rail system (108) comprises an operating area (20); a plurality of container handling vehicles (201; 301; 401) operating on the rails (110, 111) in the operating area (20); transport vehicle (501′) movable on the rail system (108), the transport vehicle (501′) comprising an enclosure defining an enclosed first area (510) for transporting a person within, the enclosure comprising a lockable barrier (520′) configured to provide access for a person into the first area (510); a control system comprising a transmitter and a receiver for communication with the container handling vehicles (201; 301; 401) and the first transport vehicle (501′); the transport vehicle comprises a receiver and is configured to receive routing instructions from the control system (500); a second area (30; 510′), partitioned from the operating area (20) and comprising a lockable barrier (31; 521′) configured to provide access for a person into the second area from the first area (510); wherein, when the transport vehicle (501′) is within the operating area (20), the lockable barrier (520′) for the enclosure and the lockable barrier (31; 521′) for the second area are configured to: unlock when the transport vehicle (501′) is at a personnel transfer position (10); and-lock when the transport vehicle (501′) is not at the personnel transfer position (10). It is further described a method of transferring a person between the first area and the second area.

The invention relates to an automated storage and retrieval system for safe entry and exit of a person into a transport vehicle on a live grid. The automated storage and retrieval system comprises logically operable barriers which only unlocks under given prerequisites. An associated method is also claimed.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set of parallel rails 110, and the second set of wheels 201c,301c,401c is arranged to engage with two adjacent rails of the second set of parallel rails 111. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 404d suspended from lifting bands 404a. The lifting bands 404a may provide power and communication between the container handling vehicle and the lifting frame 404d. The lifting frame 404d may comprise gripping engaging devices/grippers 404b for connection to gripping recesses of a storage container 106. Guide pins 404c assist in aligning the grippers 404b relative the gripping recesses of the storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 (showing a cavity-type container handling vehicles) and as described in e.g. WO2015/193278A1 and WO2019/206487A1, the contents of which are incorporated herein by reference.

FIG. 3 shows an alternative configuration of a container handling vehicle 301 with a cantilever construction (referred to as a cantilever-type container handling vehicle). Such a vehicle is described in detail in e.g. NO317366, the contents of which are also incorporated herein by reference.

The cavity-type container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity-type container handling vehicles 401 shown in FIGS. 4 and 5 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a drop-off port column where the container handling vehicles 201,301,401 can drop off storage containers 106 to be transported to an access or a transfer station, and the second port column 120 may be a pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075937A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 116, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

An objective of the invention is to provide safe access of operators or personnel on an active or “live” automated storage and retrieval system.

### SUMMARY OF THE INVENTION

The present invention is set forth and characterized in the independent claims, while the dependent claims describe other optional features.

The invention relates to an automated storage and retrieval system for safe entry and exit of a person into a transport vehicle on a live grid. The automated storage and retrieval system comprises logically operable barriers which only unlocks under given prerequisites.

Common to all of the examples of the invention as described herein is the possibility of entering and exiting a transport vehicle on a grid which is live. “Live” shall be understood that it is possible to enter and exit a transport vehicle with personnel on a part of an automated storage and retrieval system where the container handling vehicles described e.g. with reference to FIGS. 1-4 operate without shutting down the system.

The present invention relates to an automated storage and retrieval system comprising:
a rail system comprising a first set of parallel rails extending in a first direction across the top of a frame structure formed by a plurality of upright members, and a second set of parallel rails in the horizontal plane arranged in a second direction perpendicular to the first set of parallel rails, to guide movement of container handling vehicles in the first direction and the second direction, and wherein the rail system comprises an operating area;
a plurality of container handling vehicles operating on the rails in the operating area;
transport vehicle movable on the rail system, the transport vehicle comprising an enclosure defining an enclosed first area for transporting a person within, the enclosure comprising a lockable barrier configured to provide access for a person into the first area;
a control system comprising a transmitter and a receiver for communication with the container handling vehicles and the first transport vehicle;
the transport vehicle comprises a receiver and is configured to receive routing instructions from the control system;
a second area, partitioned from the operating area and comprising a lockable barrier configured to provide access for a person into the second area from the first area;
   wherein, when the transport vehicle is within the operating area, the lockable barrier for the enclosure and the lockable barrier for the second area are configured to:
unlock when the transport vehicle is at a personnel transfer position; and
lock when the transport vehicle is not at the personnel transfer position.

The transport vehicle is a vehicle of sufficient size for a person, e.g. an operator or other personnel, to enter into or onto it. When the person is inside or on the transport vehicle, he/she is protected against the container handling vehicles operating in the operating area. The enclosure may encircle the person or it may provide all round protection, for example, through including a roof. When the person is inside or on the transport vehicle, the person is protected against the container handling vehicles operating in the operating area.

The transport vehicle may be a transport vehicle with a primary task of transporting a person or personnel.

Alternatively, the transport vehicle may be a vehicle which normally has other primary tasks such as e.g. storage container handling tasks, picking tasks, etc. and which has a person transport or personnel transport function as a secondary task.

The lockable barriers can be arranged in the sides of the transport vehicle and the second area if the second area is arranged next to the transport vehicle. Alternatively, if the second area is located above the transport vehicle, the lockable barriers can be arranged in a roof or ceiling of the transport vehicle and in the floor of the second area. As a further alternative, if the second area is arranged below the transport vehicle, the lockable barriers can be arranged in a floor of the transport vehicle and in the roof or ceiling of the second area

The lockable barrier of the enclosure and the lockable barrier of the second area are operable between a state where they are unlocked allowing passage therethrough and a state where they are locked preventing passage therethrough, such that the barriers prevent passage of a person except when the transport vehicle is positioned at the personnel transfer position

The lockable barrier of the transport vehicle can thus only be unlocked and opened when the transport vehicle is positioned at the personnel transfer position.

When the lockable barriers are locked, they are also always closed preventing passage of a person therethrough.

When the lockable barriers are unlocked, they are either open allowing passage of a person therethrough or they can be opened such that a person is allowed to pass therethrough.

The personnel transfer position is a position locked by the control system. For example, the personnel transfer position is “locked” by the control system such that it is no, or at least a greatly reduced risk, that the transport vehicle moves unintentionally when at the personnel transfer position.

When the lockable barrier of the transport vehicle and the lockable barrier of the second area are arranged directly next to each other, the risk of an operator's impact with a container handling vehicle when moving between the first area and the second area is eliminated or at least greatly minimized. I.e. it is preferably no cells between the first area and the second area, such that the person can move directly between the first area and the second area. As such, although the transport vehicle is positioned within the operating area, the position within the operating area next to the barrier of the second area can be seen as a safe position where it is not a risk that the person is hit or collides with a container handling vehicle operating in the operating area.

The operating area is preferably a “live container handling vehicle operating area”.

The barrier of the transport vehicle and the barrier of the second area may be fail-safe locked.

The transport vehicle may comprise a first set of wheels for driving in the first direction and a second set of wheels for driving in the second direction.

As an alternative to wheels, the transport vehicle may have belts for moving on top of the rail system.

The transport vehicle may comprise a wheel lift mechanism operable between a first position in which the first set of wheels is above the second set of wheels such that the second set of wheels is in contact with the rail system, and a second position in which the first set of wheels is below the second set of wheels such that the first set of wheels is in contact with the rail system.

The transport vehicle may comprise a wheel drive motor for driving the first set of wheels and/or the second set of wheels.

The wheel drive motor, also denoted vehicle drive, provides for a self-moving transport vehicle. There may be one wheel drive motor for driving both the wheels in the first set of wheels and the wheels in the second set of wheels. Alternatively, there may be one wheel drive motor for driving the first set of wheels and one motor for driving the second set of wheels.

The control system may comprise a verification device for verifying that the transport vehicle is at the personnel transfer position.

The verification device may be one or more sensors at or close to the personnel transfer position. The one or more sensors may be configured to confirm that the transport vehicle is at the personnel transfer position. Such confirmation may be sent to the control system.

Alternatively, the verification device can form part of the control system in the form of a camera visually confirming position of the transport vehicle.

The personnel transfer position may be adjacent the barrier of the second area.

The personnel transfer position is preferably adjacent the barrier of the second area such that the barriers are next to or at each other minimizing the risk of a person's impact with a container handling vehicle when moving between the first area and the second area.

There is preferably no cells between the first area and the second area. This makes it possible for a person to move directly between the first area and the second area.

As such, although the transport vehicle is positioned within the operating area, when the transport vehicle is positioned at the personnel transport position, the personnel transfer position can be seen as a safe position where it is not a risk that the person is hit or collides with a container handling vehicle operating in the operating area.

The barriers could also, or in addition to being directly next to each other, be aligned with each other when the transport vehicle is at the personnel transfer position. For example, the barriers can be like arms, one on the vehicle, the other on the second area, the arms being pivotal about axes which are diametrically opposed on the walkway such that one barrier opens and pivots through 90 degrees to form a side of a passageway and the other barrier does the same to form the other side of the passageway. They may be spaced apart by the length of the barrier when the vehicle is positioned in the personnel transfer position.

The transport vehicle may comprise an emergency stop. The emergency stop may comprise a transmitter configured to transmit an emergency stop signal to the control system for shutting down the automated storage and retrieval system.

The emergency stop can be connected to the control system such that upon a signal from the emergency stop, the control system can immediately shut down the automated storage and retrieval system. For example, the emergency stop may comprise a transmitter and the control system may comprise a receiver for receiving a signal from the transmitter. The control system may then send stop signal to all vehicles or it may cut the power.

Similarly, the second area may comprise an emergency stop with similar features and functions.

The transport vehicle may comprise a lock status detector configured to detect whether the barrier on the transport vehicle is unlocked or locked. The lock status detector may comprise a transmitter for communication with the control system.

The second area may comprise a lock status detector configured to detect whether the lockable barrier of the second area is unlocked or locked. The lock status detector may comprise a transmitter for communication with the control system.

If at least one of the lock status detectors detects that the respective lockable barrier is unlocked, the transmitters of the lock status detectors may be arranged to transmit a signal to the control system such that the control system does not transmit routing instructions to the transport vehicle.

The transmitters may be configured to communicate with each other overriding routing instructions from the control system such that if the lockable barriers are unlocked, the first transport vehicle is arranged to stand still ignoring any routing instructions from the control system. This provides a safety feature in that the transport vehicle does not move when any of the lock status detectors detects that any of the barriers are unlocked.

The transport vehicle may comprise a support to help stabilize the transport vehicle.

The support may be movable between a raised position where it is lifted from the rail system and a lowered position where it is in contact with the rail system.

The support is preferably configured to interact with the rail system. The support may interact with the rail system in order to stabilize the transport vehicle during entering and exit of a person. The support may be used in addition to lowering all wheels into contact with the rail system during entering and exit of a person. It may also provide for additional support which may be required when bringing container handling vehicles, tools etc. into or out of the first area of the transport vehicle.

The second area may be a safe area for performing service on the container handling vehicles. The second area may have rails such that the container handling vehicles in need of maintenance or service can be pushed into the safe area on the rails or operate by self-movement.

The container handling vehicles is preferably prevented from self-movement when in the safe area. Self-movement of the container handling vehicles may be prevented by pushing the emergency stop button of the container handling vehicles. Then there is no risk the container handling vehicles will unintentionally move.

The second area may be an area within the operating area. The second area may thus be a temporary “island” within the operating area. The island may be a temporary or a permanent area. The temporary or permanent area may be used for protecting personnel when doing maintenance, repair and/or installation within the operating area. I.e., while the operating area is operational, i.e. “live”, the second area is protected from the operating area.

If the second area is for example a temporary area, it may serve as a safe area for e.g. performing maintenance or repair on:
parts of the rail system,
on upright members forming part of the frame structure, or
chargers for the container handling vehicles, where the chargers can be arranged within the temporary second area or in the proximity of the second area.

The second area may be a second transport vehicle comprising an enclosure defining the second area for transporting a person within. The second area may thus be a second transport vehicle. The second transport vehicle may be identical to the transport vehicle or it may be a container handling vehicle with sufficient space for a person to enter into or onto it. In some situations, it may be required to transfer a person from the transport vehicle to the second transport vehicle. Such situations may e.g. be if the transport vehicle malfunctions or if one or more personnel shall be transported over large distances using the second transport vehicle.

The lockable barriers may be configured to:
unlock when movement of the transport vehicle is prevented relative to the second area; and
lock when movement of the transport vehicle is allowed relative to the second area.

The barriers can thus only be unlocked when the transport vehicle is at the personnel transfer position and prevented from movement by e.g. the control system.

It is further described a method of unlocking a lockable barrier of a transport vehicle and a lockable barrier in a second area in an automated storage and retrieval system by using a control system, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the second area is partitioned from the operating area and comprises a lockable barrier configured to provide access for a person into the second area from the first area, the automated storage and retrieval system comprising a grid-based rail system and the method comprises the steps of using the control system to:
position the transport vehicle at a personnel transfer position;
confirm that the transport vehicle is at the personnel transfer position, and reposition the transport vehicle if the transport vehicle is not at the personnel transfer position;
set the vehicle drive to inhibited mode;
set the wheel lift mechanism to inhibited mode;
request to unlock the lockable barrier of the transport vehicle and change the state of the lockable barrier to unlocked;
request to unlock the lockable barrier of the second area and change the state of lockable barrier to unlocked.

The term inhibited mode refers to a mode of the wheel lift mechanism and vehicle drive where these components are set to be inactive, i.e. they are not allowed to perform their dedicated functions of lifting or lowering one of the sets of wheels and drive the vehicle.

It is further described a method of locking a lockable barrier of a transport vehicle and a lockable barrier in a second area in an automated storage and retrieval system by using a control system, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the second area is partitioned from the operating area and comprises a lockable barrier configured to provide access for a person into the second area from the first area, the automated storage and retrieval system comprising a grid-based rail system and the method comprises the steps of using the control system to:
request to move the transport vehicle from a personnel transfer position next to the second area;
confirm that the lockable barrier of the transport vehicle is locked, and if the lockable barrier is not locked, abort and wait for confirmation that the lockable barrier is locked;
confirm that the lockable barrier of the second area is locked, and if the lockable barrier is not locked, abort and wait for confirmation that the lockable barrier is locked;
set the wheel lift mechanism to operation mode;
set the vehicle drive to operation mode;
move away from the personnel transfer position.

The term operation mode when referring to the wheel lift mechanism and vehicle drive refers to normal operation mode, i.e. when the wheel lift mechanism is allowed to raise and lower one of the set of wheels and the vehicle drive is allowed to move the transport vehicle.

The second area can be a safe area for performing service on one or more container handling vehicles.

The second area can be a second transport vehicle.

When the transport vehicle is at the personnel transfer position, the method may comprise a step of:
lower all wheels of the first set of wheels and the second set of wheels to the rail system.

When the transport vehicle is at the personnel transfer position, the method may comprise a step of:
lower a support into contact with the rail system.

The support is preferably configured to interact with the rail system. The support may interact with the rail system in order to stabilize the transport vehicle during entering and exit of a person. The support may be used in addition to lowering all wheels into contact with the rail system during entering and exit of a person. It may also provide for additional support which may be required when bringing container handling vehicles, tools etc. into or out of the first area of the transport vehicle.

The automated storage and retrieval system may comprise a plurality of upright members and each storage column is defined by four of the upright members.

The rail system may be arranged on top of the upright members, the rail system comprising a first set of parallel rails and a second set of parallel rails arranged perpendicular to the first set of rails. The first and second set of rails providing a horizontal grid-based rail system defining a plurality of grid cells. The first and second set of rails of the rail system may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell”. In arrangements where one direction of rails has only a single track, the grid cell may extend a full rail-width on those sides.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the automated storage and retrieval system and the goods to be stored. The gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The invention may be used in connection with storage containers and systems as described above. However, other areas where the disclosed automated storage and retrieval system and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of the container handling vehicle in FIG. 4 without side and top panels;

FIG. 6A shows details of a first exemplary transport vehicle for the automated storage and retrieval system;

FIG. 6B is a side view of a second example of a transport vehicle for the automated storage and retrieval system;

FIG. 7A shows a perspective view of an automated storage and retrieval system comprising a rail system with an operating area, a second area in the form of a safe area partitioned from the operating area where the second area comprises rails and a floor, and a transport vehicle which moves on the rail system, the transport vehicle comprising an enclosure defining an enclosed first area for transporting a person within, the enclosure comprising a lockable barrier configured to provide access for a person into the first area;

FIG. 7B is a similar view as in FIG. 7A, but in FIG. 7B the transport vehicle has moved to a position next to the second area such that one of the lockable barriers of the transport vehicle is positioned in front of a lockable barrier of the second area, however the transport vehicle is allowed to move relative the second area since the barriers are locked;

FIG. 7C is a similar view of FIG. 7B, but in FIG. 7C the lockable barrier of the transport vehicle and the lockable barrier of the second area are unlocked because movement of the transport vehicle relative to the second area is physically prevented;

FIGS. 8A-8B are a side perspective views of an automated storage and retrieval system comprising: a rail system which comprises an operating area, a container handling vehicle operates on rails in the operating area, a transport vehicle operates on the rail system and comprises an enclosure defining an enclosed first area for transporting a person within, the enclosure comprising a lockable barrier configured to provide access for a person into the first area, and a second area without rails, where the second area is in the form of a safe area partitioned from the operating area and comprising a lockable barrier configured to provide access for a person into the second area from the first area;

FIG. 9A shows a perspective view of an automated storage and retrieval system comprising a rail system with an operating area, two transport vehicles within the operating area and where the vehicles are arranged at a distance from each other, wherein the first transport vehicle comprises an enclosure defining an enclosed first area for transporting a person within, the enclosure comprising a lockable barrier configured to provide access for a person into the first area, and the second the transport vehicle comprises an enclosure defining an enclosed second area for transporting a person within, the enclosure comprising a lockable barrier configured to provide access for a person into the second area;

FIG. 9B is a similar view as in FIG. 8A where the transport vehicles positioned next to each other although with the barriers locked preventing opening of the sliding doors, so it is not possible for a person to pass from one vehicle to the other vehicle;

FIG. 9C is a similar view as in FIG. 8B with the transport vehicles positioned next to each other, but where the barriers are unlocked such that the sliding doors in each of the enclosures of the first and second areas are open making it possible for a person to pass from one vehicle to the other vehicle;

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

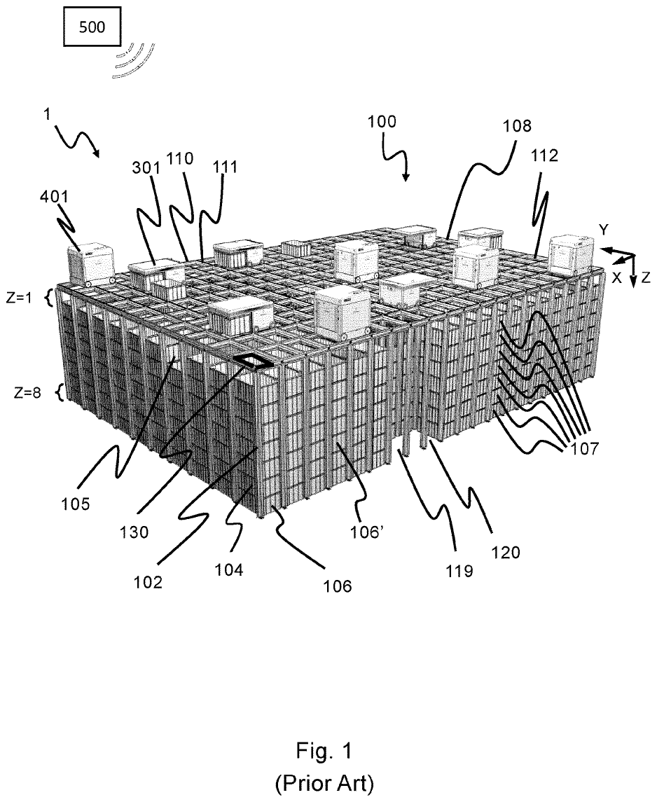

A frame structure 100 of the automated storage and retrieval system 1 may be constructed in a similar manner to the prior art frame structure 100 described above in connection with FIG. 1. That is, the frame structure 100 may comprise a number of upright members 102, and comprise a rail system 108 extending in the first direction (X direction) and the second direction (Y direction). I.e. the rail system 108 may be arranged on top of the upright members 102, the rail system 108 comprising a first set of parallel rails 110 and a second set of parallel rails 111 arranged perpendicular to the first set of rails 110. The first and second set of rails 110,111 providing a horizontal grid-based rail system 108 defining a plurality of grid cells 130. The first and second set of rails 110,111 of the rail system 108 may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell” 130. In arrangements where one direction of rails has only a single track, the grid cell 130 may extend a full rail-width on those sides.

The frame structure 100 may comprise storage compartments in the form of storage columns 105 provided between the members 102 wherein storage containers 106 may be stackable in stacks 107 within the storage columns 105.

The frame structure 100 can be of any size. In particular, it is understood that the frame structure can be considerably wider and/or longer and/or deeper than disclosed in FIG. 1. For example, the frame structure 100 may have a horizontal extent of more than 700×700 columns and a storage depth of more than twelve containers.

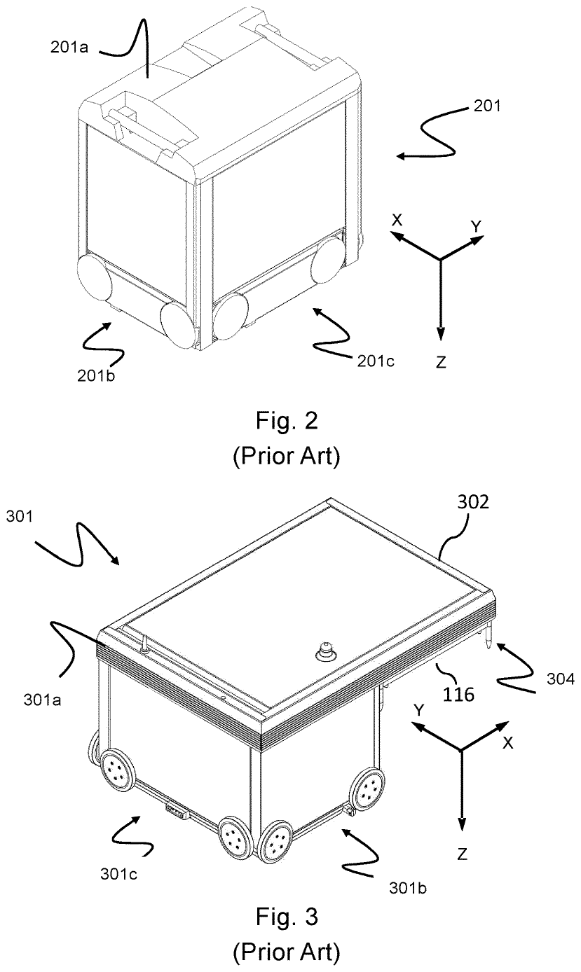

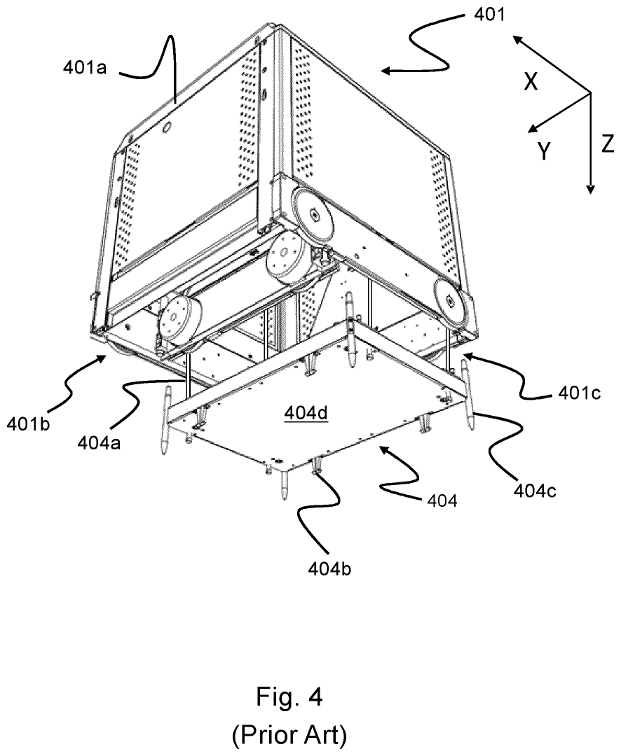

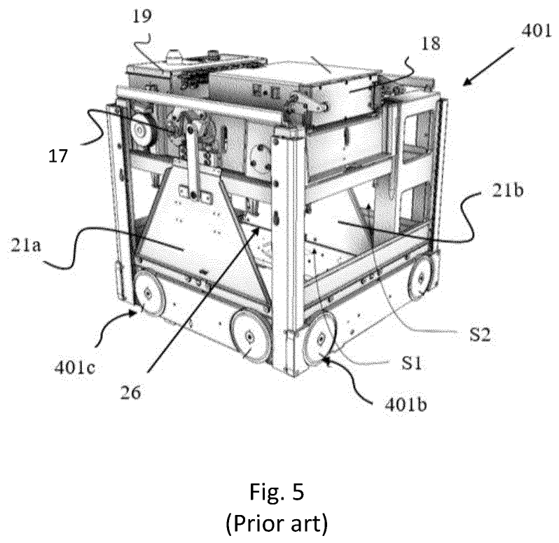

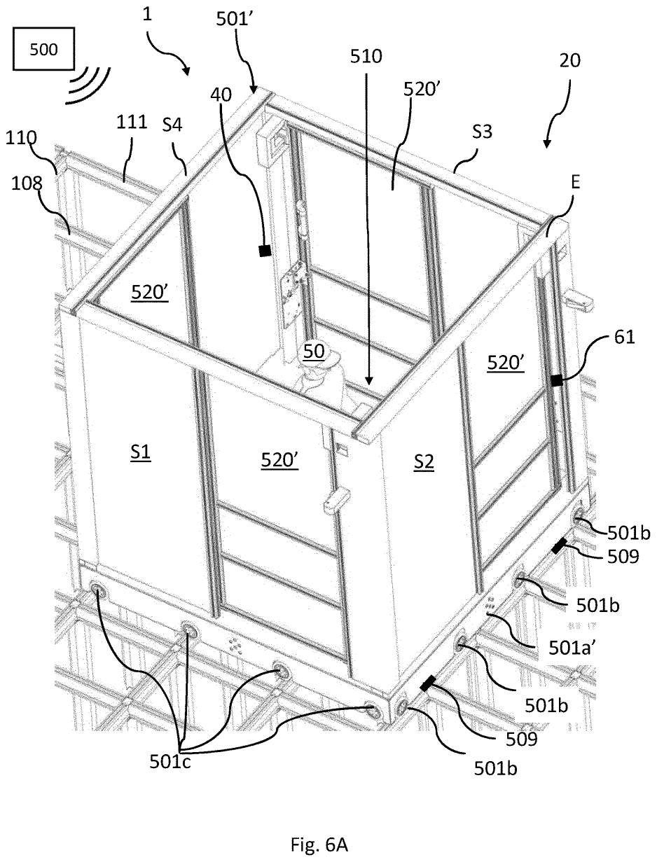

The prior art container handling vehicles comprising a cavity for accommodating a storage container (cavity-type container handling vehicles), see FIGS. 2, 4 and 5, have certain advantageous features. In particular, the guidance/support provided to a storage container when accommodated in the cavity entails that the cavity-type container handling vehicles may have increased acceleration/deceleration relative to the cantilever-type container handling vehicle 301 shown in FIG. 3. However, the potential increase in acceleration/deceleration is not fully realized due to instability of the cavity-type container handling vehicles. The instability is caused by the cavity-type container handling vehicles 201,401 having most of the drive, power, control and lifting components arranged above the cavity, providing a high centre of gravity.

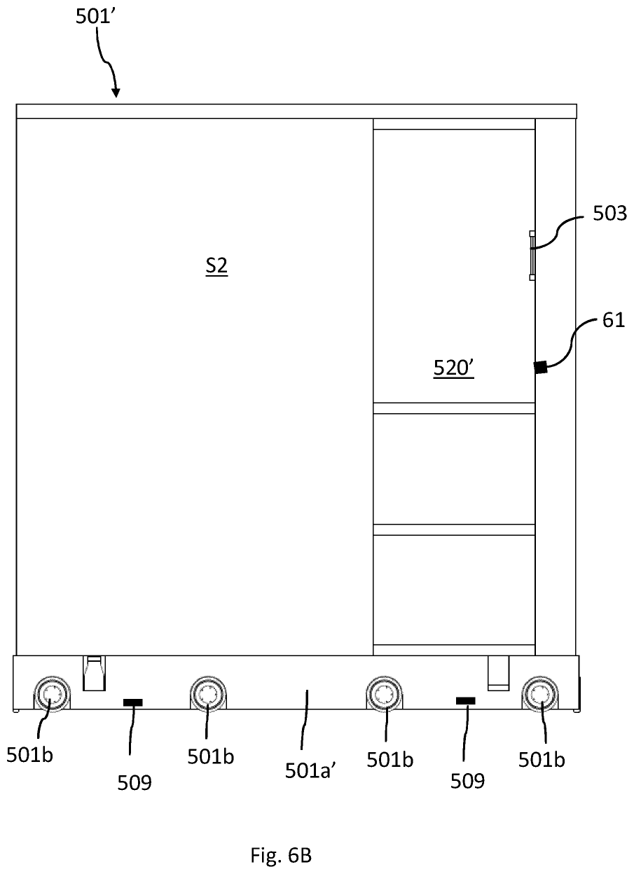

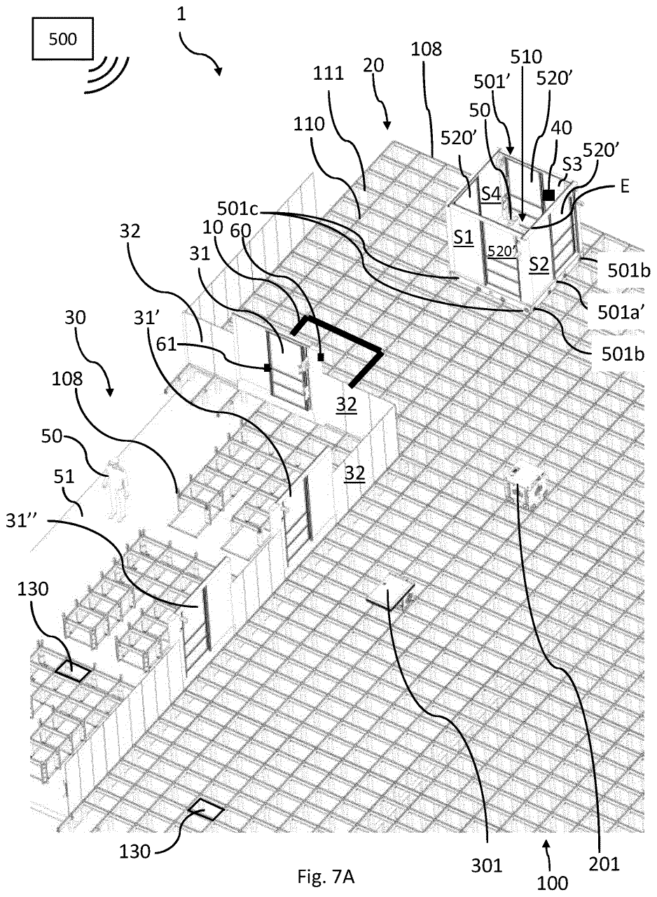

FIG. 6A shows details of an exemplary transport vehicle 501′ for the automated storage and retrieval system 1.

The transport vehicle 501′ vehicle comprises an enclosure E defining an enclosed first area 510 for transporting a person 50 within. The enclosure E is formed by four sides, i.e. first side S1, second side S2, third side S3 and fourth side S4. In the example in FIG. 6 there is arranged one lockable barrier 520′ configured to provide access for a person into the first area 510 on each of the four sides S1,S2,S3,S4 such that the transport vehicle 501′ can connect to a second area 30 arranged on any of the four sides S1,S2,S3,S4.

The transport vehicle 501′ features a vehicle body 501a′. A first set of wheels 501b for driving in the first direction X and a second set of wheels 501c for driving in the second direction Y are arranged on the vehicle body 501a′.

Although not shown, the transport vehicle 501′ preferably comprises a wheel lift mechanism operable between a first position in which the first set of wheels 501b is above the second set of wheels 501c such that the second set of wheels 501c is in contact with the rail system 108, and a second position in which the first set of wheels 501b is below the second set of wheels 501c such that the first set of wheels 501b is in contact with the rail system 108.

Furthermore, although not shown, the transport vehicle 501′ preferably comprises a vehicle drive or wheel drive motor for driving the first set of wheels 501b and/or the second set of wheels 501c for moving the transport vehicle 501′ on the rail system.

The transport vehicle 501′ is preferably in communication with the control system 500 such that the control system 500 gives instructions to the transport vehicle 501′ where to move within the operating area 20 of the rail system 108 without the risk of collision with the container handling vehicles 201,301,501.

The transport vehicle 501′ may further comprise an emergency stop 40. The emergency stop 40 may comprise a transmitter configured to transmit an emergency stop signal to the control system 500. For example, the emergency stop may comprise a transmitter and the control system 500 may comprise a receiver for receiving a signal from the transmitter. The control system may then send stop signal to all container handling vehicles and transport vehicles or it may cut the power.

The transport vehicle 501′ may comprise a lock status detector 61 configured to detect whether the barrier 520′ on the transport vehicle 501′ is unlocked or locked. The lock status detector 61 may comprise a transmitter (not shown) for communication with the control system 500.

The transport vehicle 501′ may comprise one or more supports 509 for stabilizing the transport vehicle 501′. The support 509 is movable between a raised position where it is lifted from the rail system 108 and a lowered position where it is in contact with the rail system 108. The support 509 is preferably configured to interact with the rail system 108. The support 509 may interact with the rail system 108 in order to stabilize the transport vehicle during entering and exit of a person. The support 509 may be used in addition to lowering all wheels into contact with the rail system 108 during entering and exit of a person 50. It may also provide for additional support which may be required when bringing container handling vehicles 201,301,401, tools etc. into or out of the first area 510 of the transport vehicle 501′.

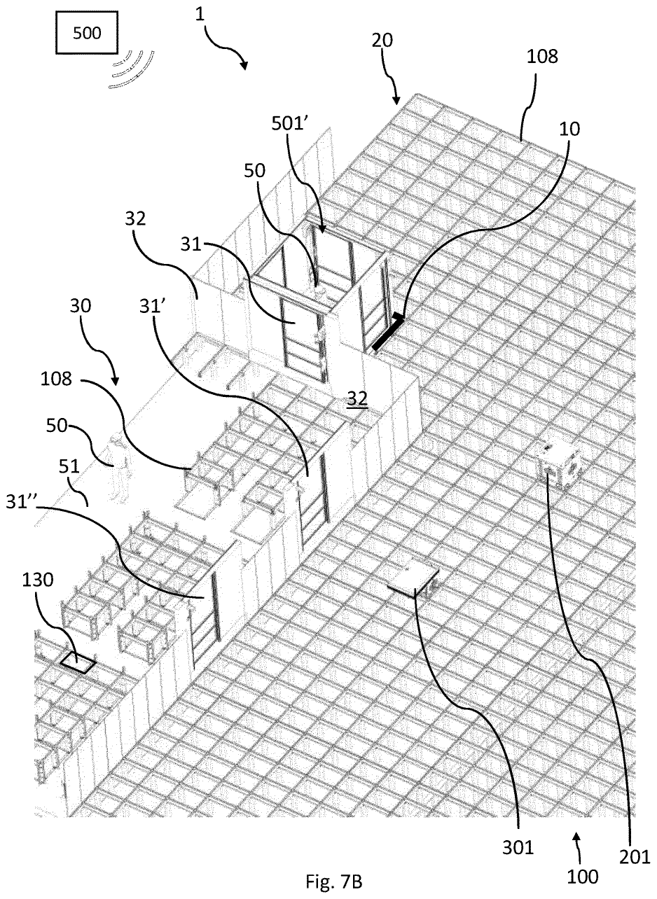

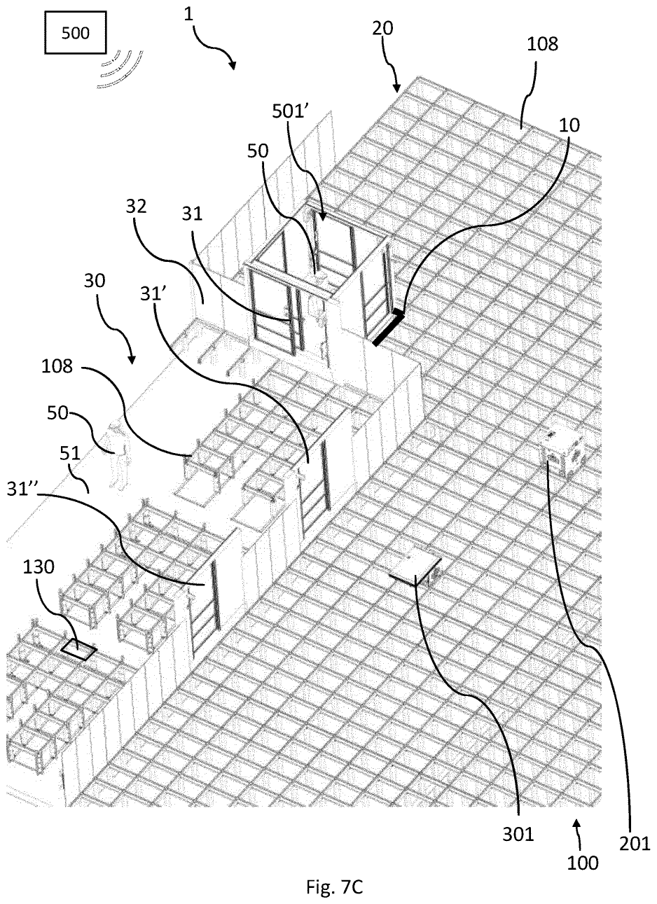

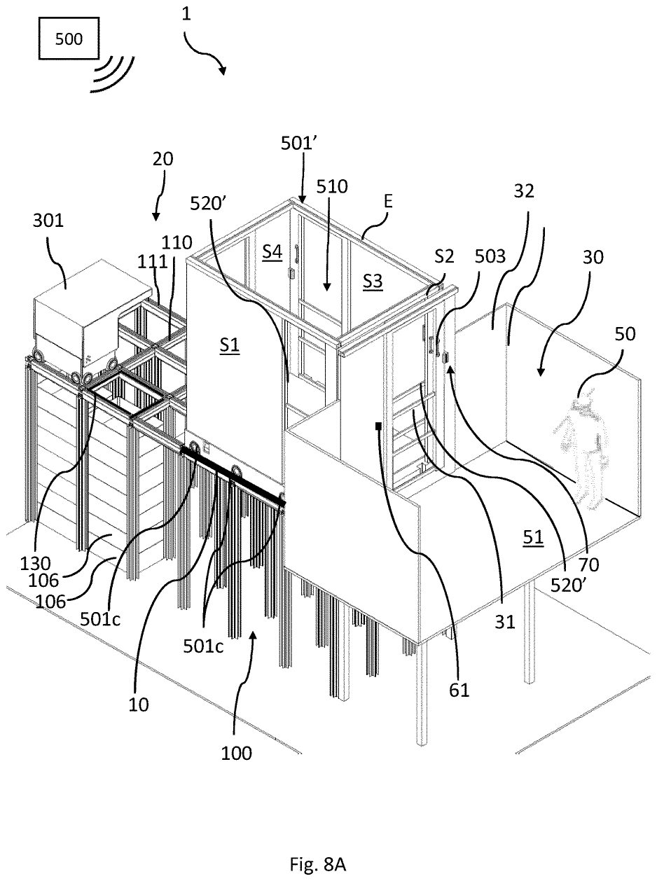

FIG. 6B is a side view of a second example of a transport vehicle 501′ vehicle for the automated storage and retrieval system 1. The transport vehicle 501′ in FIG. 7 has features in common with the exemplary transport vehicle in FIG. 6, which features will not be repeated herein.

FIG. 7A shows a perspective view of an automated storage and retrieval system 1 comprising a rail system 108 with an operating area 20, a second area 30 in the form of a safe area partitioned from the operating area 20 where the second area comprises rails 110,111 and a floor 51. A transport vehicle 501′ moves on the rail system 108 and comprises an enclosure E defining an enclosed first area 510 for transporting a person 50 within. The enclosure E comprising a total of four lockable barriers 520′ configured to provide access for a person 50 into the first area 510.

The disclosed transport vehicle 501′ being identical to the transport vehicle 501′ in FIG. 6A.

As shown in FIG. 7A, a person 50 is transported by the transport vehicle 501′. When the person 50 is within the first area 510 of the transport vehicle 501′, the person is physically protected from the container handling vehicles 201,301,401 operating in the operating area 20. The person 50 enters and exits the first area 510 through any of the lockable barriers 520′ when the lockable barriers 520′ are unlocked allowing passage therethrough. A personnel transfer position 10 is indicated next to the lockable barrier 31 of the second area 30. A verification device 60 is arranged at the personnel transfer position 10.

The second area 30 may comprise a lock status detector 61 configured to detect whether the lockable barrier 31 of the second area 30 is unlocked or locked. The lock status detector 61 may comprise a transmitter (not shown) for communication with the control system 500.

FIG. 7B is a similar view as in FIG. 7A, but in FIG. 7B the transport vehicle 501′ has moved to the personnel transfer position 10 next to the second area 30 such that one of the lockable barriers 520′ of the transport vehicle 501′ is positioned in front of a lockable barrier 31 of the second area 30. However, the transport vehicle 501′ is allowed to move relative the second area 30 since the barriers 520′,31 are still locked by the control system 500.

As indicated above, the transport vehicle 501′ is preferably configured to receive routing instructions from the control system 500. When a person 50 shall enter or exit the first area 510, such routing instructions may be to the position next to the barrier 31 of the second area 30 as illustrated in FIG. 7B (and FIG. 7C).

FIG. 7C is a similar view of FIG. 7B, but in FIG. 7C the lockable barrier 520′ of the transport vehicle 501′ and the lockable barrier 31 of the second area 30 are unlocked by the control system 500. Movement of the transport vehicle 501′ away from the personnel transfer position 10 is prevented by the control system 500.

An example sequence of unlocking the barriers 520′,31 of the transport vehicle 501′ and the second area 30 using the control system 500 may comprise:
position the transport vehicle 501′ at the personnel transfer position 10;
confirm that the transport vehicle 501′ is at the personnel transfer position 10, and reposition the transport vehicle 501′ if the transport vehicle 501′ is not at the personnel transfer position 10;
set the vehicle drive to inhibited mode;
set the wheel lift mechanism to inhibited mode;
request to unlock the lockable barrier 520′ of the transport vehicle 501′ and change the state of the lockable barrier 520′ to unlocked;
request to unlock the lockable barrier 31 of the second area 30 and change the state of lockable barrier 31 to unlocked.

An example sequence of locking the barriers 520′,31 of the transport vehicle 501′ and the second area 30, after the person 50 has entered the transport vehicle 501′, using the control system 500 may comprise:
request to move the transport vehicle 501′ from a personnel transfer position 10 next to the second area 30;
confirm that the lockable barrier 520′ of the transport vehicle 501′ is locked, and if the lockable barrier 520′ is not locked, abort and wait for confirmation that the lockable barrier 520′ is locked;
confirm that the lockable barrier 31 of the second area 30 is locked, and if the lockable barrier 31 is not locked, abort and wait for confirmation that the lockable barrier 31 is locked;
set the wheel lift mechanism to operation mode;
set the vehicle drive to operation mode;
move away from the personnel transfer position 10.

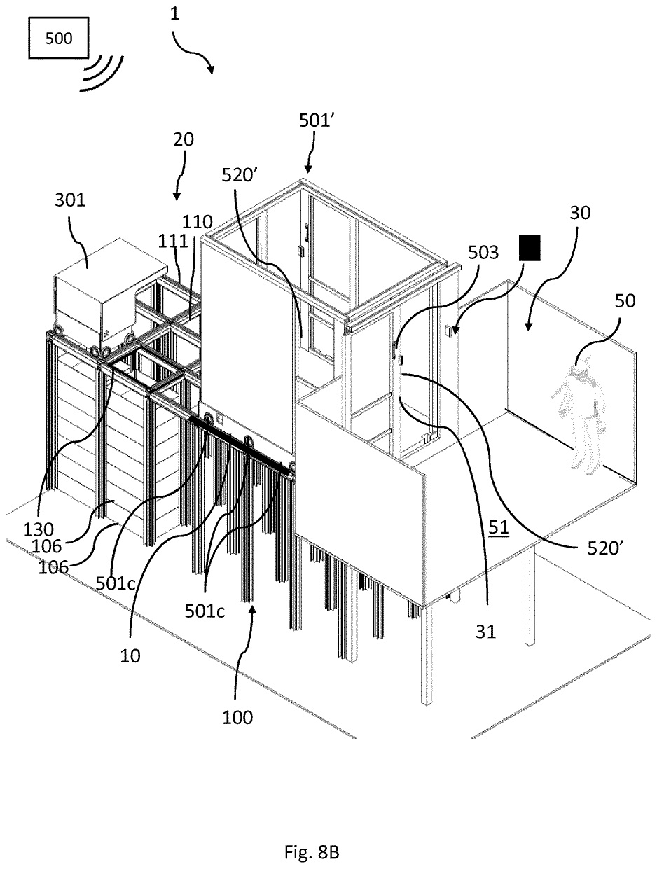

FIGS. 8A-8B are a side perspective views of an automated storage and retrieval system 1 comprising: a rail system 108 which comprises an operating area 20, a container handling vehicle 301 operates on rails 110,111 in the operating area 20, a transport vehicle 501′ operates on the rail system 108 and comprises an enclosure E defining an enclosed first area 510 for transporting a person 50 within. The enclosure E comprising a total of four lockable barriers 520′ configured to provide access for a person 50 into the first area 510, and a second area 30 without rails. The second area 30 is in the form of a safe area partitioned from the operating area 20 and comprising a lockable barrier 31 configured to provide access for a person 50 into the second area 30 from the first area 510. The transport vehicle 501′ is positioned at the personnel transfer position 10 and is identical to the transport vehicle 501′ in FIG. 6B.

In FIG. 8A both of the lockable barriers 520′, 31 are locked preventing access for the person 50 therethrough through that both of the lockable barriers 520′,31 are locked by the control system 500.

When comparing FIG. 8B with FIG. 8A, one can see that both of the lockable barriers 520′, 31 are unlocked and open allowing access for the person 50 therethrough. This is due to that the control system 500 has unlocked the barriers 520′,31.

The example sequences described in relation to FIGS. 7A-7C to lock and unlock the barriers 520′,31 are applicable to the example in FIGS. 8A and 8B as well, and will thus not be repeated herein.

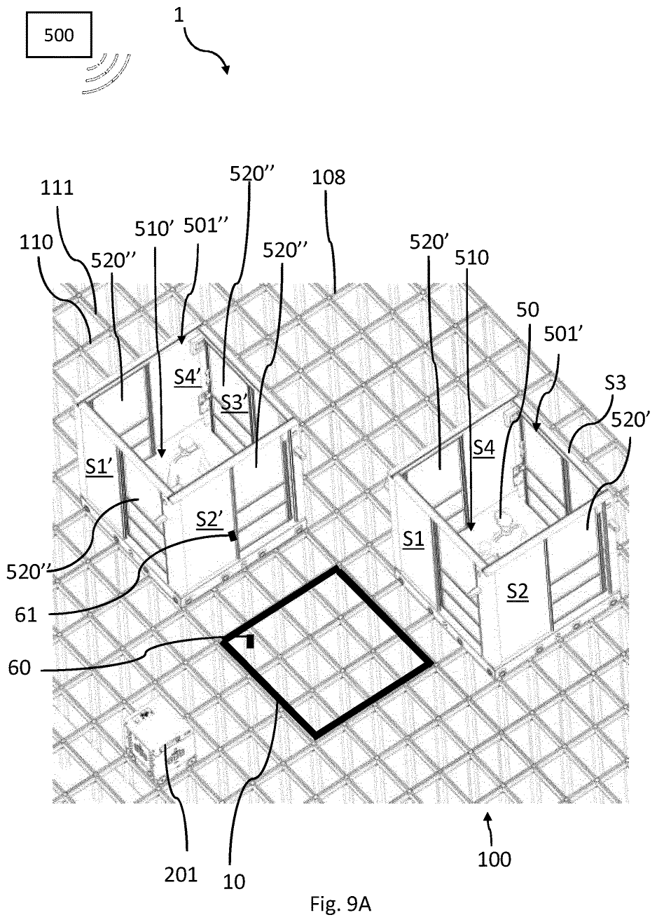

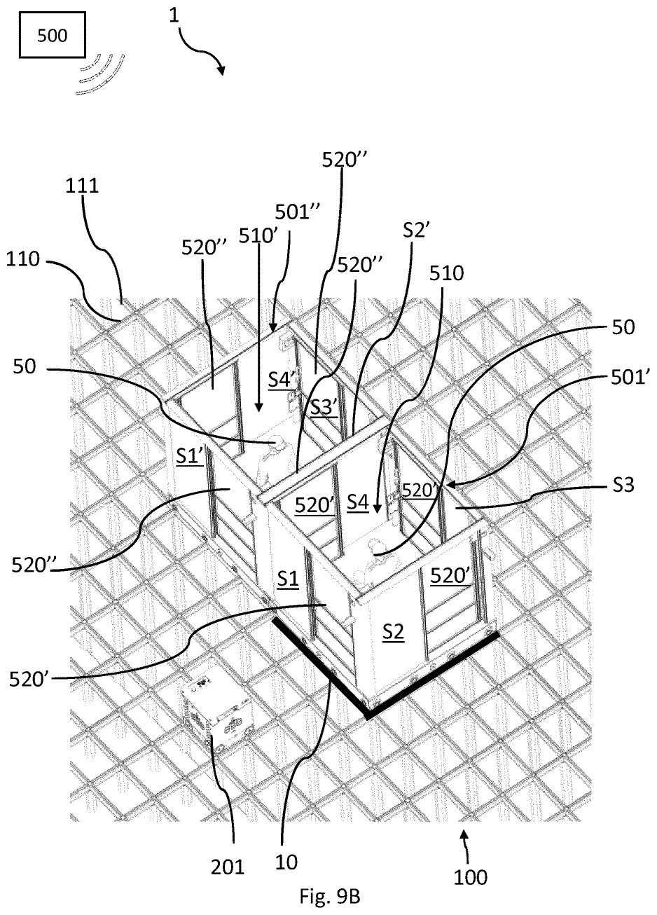

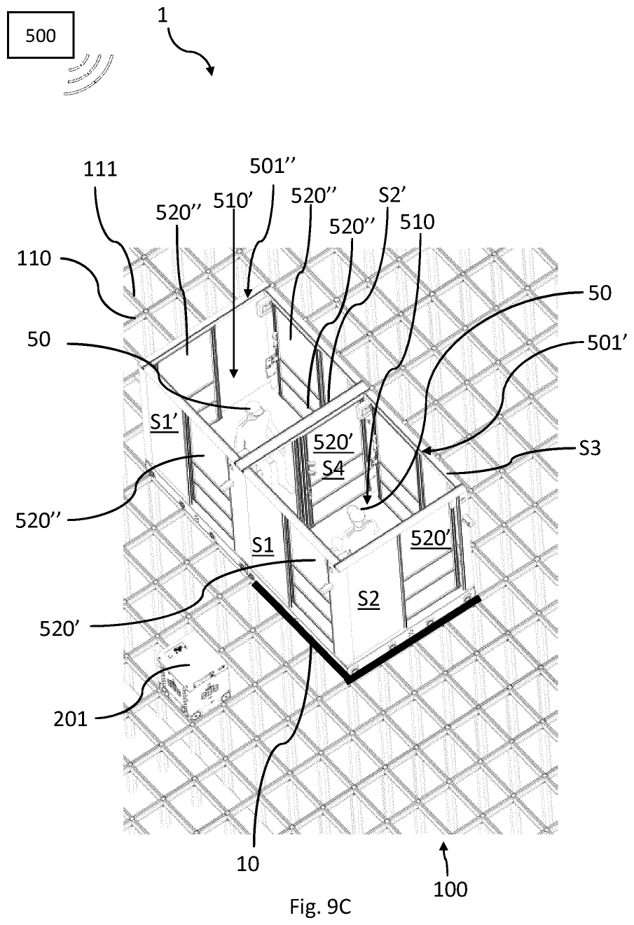

FIG. 9A shows a perspective view of an automated storage and retrieval system 1 comprising a rail system 108 with an operating area 20, two transport vehicles 501′,501″ within the operating area 20. Both of the transport vehicles 501′,501″ are identical to the transport vehicle 501′ shown in detail on FIG. 6A. The second area 510′ in this example is thus in a second transport vehicle 501″. In some situations, it may be required to transfer a person from the transport vehicle 501′ to the second transport vehicle 501″. Such situations may e.g. be if the transport vehicle 501′ malfunctions or if a person shall be transported over large distances using the second transport vehicle 501″. The second transport vehicle 501″ may be identical to the transport vehicle 501′ or it may be a container handling vehicle with sufficient space for a person to enter into or onto it.

In FIG. 9A the transport vehicles 501′,501″ are arranged at a distance from each other and there is arranged one person 50 in each of the transport vehicles 501′,501″. All of the four lockable barriers 520′ of the transport vehicle 501′ are locked. Similarly, all of the four lockable barriers 520″ of the second transport vehicle 501″ are locked. None of the transport vehicles 501′,501″ are positioned at the personnel transfer position 10 in FIG. 9A. A verification device 60 is arranged at the upright member below the personnel transfer position 10 to confirm presence of the transport vehicle 501′ at the personnel transfer position 10 and to send confirmation to the control system 500.

The second area 510′ may comprise a lock status detector 61 configured to detect whether the lockable barrier 520″ of the second area 510′ is unlocked or locked. The lock status detector 61 may comprise a transmitter (not shown) for communication with the control system 500.

FIG. 9B is a similar view as in FIG. 8A where the first and a second transport vehicles 501′,501″ are now positioned next to each other at the personnel transfer position 10 although with the barriers 520′,520″ locked preventing opening of the sliding doors, so it is not possible for a person 50 to pass from one vehicle 501′,501″ to the other vehicle 501″, 501′.

As seen in FIG. 9B, the transport vehicles the lockable barrier 520′ on the fourth side S4 of the transport vehicle 501′ is positioned next to the lockable barrier 520″ on the second side S2′ of the second transport vehicle 501″.

FIG. 9C is a similar view as in FIG. 8B with the transport vehicles 501′,501′ positioned next to each other at the personnel transfer position 10, but where the barriers 520′,520″ are unlocked such that the sliding doors in each of the enclosures E of the first and second areas 510,510′ are open making it possible for a person 50 to pass from one vehicle 501′,501″ to the other vehicle 501″, 501′. It can be clearly seen that the person 50 in the second transport vehicle 501″ is visible through the unlocked barriers 520′,520″.

An example sequence of unlocking the barriers 520′ of the transport vehicle 501′ and the second area 510′ in the second transport vehicle 501″ using the control system 500 may comprise:
position the transport vehicles 501′,501″ at the personnel transfer position 10;
confirm that the transport vehicles 501′ are at the personnel transfer position 10, and reposition the transport vehicles 501′,501″ if any of the transport vehicle 501′ are not at the personnel transfer position 10;
set the vehicle drive to inhibited mode in both of the transport vehicles 501′,501″;
set the wheel lift mechanism to inhibited mode in both transport vehicles 501′,501″;
request to unlock the lockable barrier 520′ of the transport vehicle 501′ and change the state of the lockable barrier 520′ to unlocked;
request to unlock the lockable barrier 520′ of the second area 510′ and change the state of lockable barrier 520′ to unlocked.

An example sequence of locking the barriers 520′,520″ of the transport vehicle 501′ and the second area 510′ in the second transport vehicle 501″, after the person 50 has moved between the transport vehicles 501′,501″, using the control system 500 may comprise:
request to move the transport vehicle 501′ from a personnel transfer position 10 next to the second area 510′;
confirm that the lockable barrier 520′ of the transport vehicle 501′ is locked, and if the lockable barrier 520′ is not locked, abort and wait for confirmation that the lockable barrier 520′ is locked;
confirm that the lockable barrier 521′ of the second area 510′ is locked, and if the lockable barrier 521′ is not locked, abort and wait for confirmation that the lockable barrier 521 is locked;
set the wheel lift mechanism to operation mode;
set the vehicle drive to operation mode;
move away from the personnel transfer position 10.

Common to both the example in FIGS. 8A-8C and 9A-9C, when the transport vehicle 501′ is at the position next to the barrier 31 of the second area 30 (as in FIGS. 8A and 8B) or next to the second transport vehicle 501″ (as in FIGS. 9B and 9C), the wheels in the first and second set of wheels 501b,501c may be lowered to the same level such that all of the wheels of the transport vehicle 501′ are in contact with the underlying rails 110,111 of the rail system 108. When all wheels are in contact with the underlying rails 110,111, stability of the transport vehicle 501′ is greatly improved since the risk that the transport vehicle 501′ rolls uncontrolled in any direction is eliminated. Furthermore, as an alternative or in addition to lowering all wheels to the same level, the transport vehicle 501′ may comprise a support 509 as described in relation to FIG. 6A above, where the support 509 is also lowered to provide increased stability during entering and exiting.

In the preceding description, various features of the embodiments have been described. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

List of reference numbers

| | |
|---|---|
| 1 | Prior art automated storage and retrieval system |
| 10 | Personnel transfer position |
| 20 | Operating area |
| 30 | Second area/service area |
| 31, 31′, 31″ | Lockable barrier of service area |
| 32 | Wall |
| 40 | Emergency stop |
| 50 | Person/operator |
| 51 | Floor |
| 60 | Verification device |
| 61 | Lock status detector |
| 100 | Frame structure |
| 102 | Upright member |
| 104 | Storage volume |
| 105 | Storage column |
| 106 | Storage container |
| 106′ | Particular position of storage container |
| 107 | Stack |
| 108 | Rail system |
| 110 | First set of parallel rails (in first direction (X)) |
| 111 | Second set of parallel rails (in second direction (Y)) |
| 112 | Access opening |
| 116 | Lifting device |
| 119 | Delivery column |
| 120 | Delivery column |
| 130 | Grid cell |
| 201 | Prior art container handling vehicle |
| 201a | Vehicle body of the container handling vehicle 201 |
| 201b | Drive means/wheel arrangement/first set of wheels |
| | in first direction (X) |
| 201c | Drive means/wheel arrangement/second set of wheels |
| | in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 302 | Cantilever |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 501′ | Transport vehicle |
| 501″ | Second transport vehicle |
| 501a | Vehicle body of the transport vehicle 501′ |
| 501b | First drive means/wheel arrangement/first set of wheels |
| | in first direction (X) |
| 501c | Second drive means/wheel arrangement/second set |
| | of wheels in second direction (Y) |
| 503 | Handle |
| 509 | Support |
| 510 | First area |
| 510′ | Second area in second transport vehicle 501″ |
| 520′ | Lockable barrier of the transport vehicle 501′ |
| 520″ | Lockable barrier of the second transport vehicle 501′ |
| E | Enclosure |
| X | First direction |
| Y | Second direction |
| Z | Third direction |

1.-25. (canceled)

26. An automated storage and retrieval system comprising:
a rail system comprising a first set of parallel rails extending in a first direction across a top of a frame structure formed by a plurality of upright members, and a second set of parallel rails in a horizontal plane arranged in a second direction perpendicular to the first set of parallel rails, to guide movement of container handling vehicles in the first direction and the second direction, and wherein the rail system comprises an operating area;
a plurality of container handling vehicles operating on the rails in the operating area;
a transport vehicle movable on the rail system, the transport vehicle comprising an enclosure defining an enclosed first area for transporting a person within, the enclosure comprising a lockable barrier configured to provide access for a person into the first area;
a control system comprising a transmitter and a receiver for communication with the container handling vehicles and the transport vehicle;
wherein the transport vehicle comprises a receiver and is configured to receive routing instructions from the control system;
a second area, partitioned from the operating area and comprising a lockable barrier configured to provide access for a person into the second area from the first area;
wherein, when the transport vehicle is within the operating area, the lockable barrier for the enclosure and the lockable barrier for the second area are configured to:
unlock when the transport vehicle is at a personnel transfer position; and
lock when the transport vehicle is not at the personnel transfer position.

27. The automated storage and retrieval system according to claim 26, wherein the lockable barrier of the transport vehicle and the lockable barrier of the second area are fail-safe locked.

28. The automated storage and retrieval system according to claim 26, wherein the transport vehicle comprises a first set of wheels for driving in the first direction and a second set of wheels for driving in the second direction.

29. The automated storage and retrieval system according to claim 28, wherein the transport vehicle comprises a wheel lift mechanism operable between a first position in which the first set of wheels is above the second set of wheels such that the second set of wheels is in contact with the rail system, and a second position in which the first set of wheels is below the second set of wheels such that the first set of wheels is in contact with the rail system.

30. The automated storage and retrieval system according to claim 28, wherein the transport vehicle comprises a wheel drive motor for driving the first set of wheels and/or the second set of wheels.

31. The automated storage and retrieval system according to claim 26, wherein the control system comprises a verification device for verifying that the transport vehicle is at the personnel transfer position.

32. The automated storage and retrieval system according to claim 31, wherein the verification device is one or more sensors at or close to the personnel transfer position and wherein the one or more sensors are configured to confirm that the transport vehicle is at the personnel transfer position.

33. The automated storage and retrieval system according to claim 26, wherein the personnel transfer position is adjacent the barrier of the second area.

34. The automated storage and retrieval system according to claim 26, wherein the transport vehicle comprises an emergency stop, wherein the emergency stop comprises a transmitter configured to transmit an emergency stop signal to the control system for shutting down the automated storage and retrieval system.

35. The automated storage and retrieval system according to claim 26, wherein the transport vehicle comprises a lock status detector configured to detect whether the lockable barrier on the transport vehicle is unlocked or locked, and wherein the lock status detector comprises a transmitter for communication with the control system.

36. The automated storage and retrieval system according to claim 35, wherein the second area comprises a lock status detector configured to detect whether the lockable barrier of the second area is unlocked or locked, and wherein the lock status detector comprises a transmitter for communication with the control system.

37. The automated storage and retrieval system according to claim 36, wherein, if at least one of the lock status detectors detects that the respective lockable barrier is unlocked, the transmitters of the lock status detectors are arranged to transmit a signal to the control system such that the control system does not transmit routing instructions to the transport vehicle.

38. The automated storage and retrieval system according to claim 37, wherein the transmitters are configured to communicate with each other overriding routing instructions from the control system such that if the lockable barriers are unlocked, the first transport vehicle is arranged to stand still ignoring any routing instructions from the control system.

39. The automated storage and retrieval system according to claim 26, wherein the transport vehicle comprises a support to help stabilize the transport vehicle.

40. The automated storage and retrieval system according to claim 39, wherein the support is movable between a raised position where it is lifted from the rail system and a lowered position where it is in contact with the rail system.

41. The automated storage and retrieval system according to claim 26, wherein the second area is a safe area for performing service on the container handling vehicles.

42. The automated storage and retrieval system according to claim 26, wherein the second area is an area within the operating area.

43. The automated storage and retrieval system according to claim 26, wherein the second area is a second transport vehicle comprising an enclosure defining the second area for transporting a person within.

44. The automated storage and retrieval system according to claim 26, wherein the lockable barriers are configured to:
unlock when movement of the transport vehicle is prevented relative to the second area; and
lock when movement of the transport vehicle is allowed relative to the second area.

45. A method of unlocking a lockable barrier of a transport vehicle and a lockable barrier in a second area in an automated storage and retrieval system by using a control system, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the second area is partitioned from an operating area and comprises a lockable barrier configured to provide access for a person into the second area from the first area, the automated storage and retrieval system comprising a grid-based rail system and the method comprises the steps of using the control system to:
position the transport vehicle at a personnel transfer position;
confirm that the transport vehicle is at the personnel transfer position, and reposition the transport vehicle if the transport vehicle is not at the personnel transfer position;
set the vehicle drive to inhibited mode;
set the wheel lift mechanism to inhibited mode;
request to unlock the lockable barrier of the transport vehicle and change a state of the lockable barrier to unlocked;
request to unlock the lockable barrier of the second area and change the state of lockable barrier to unlocked.

46. A method of locking a lockable barrier of a transport vehicle and a lockable barrier in a second area in an automated storage and retrieval system by using a control system, the transport vehicle comprising a vehicle drive for self-movement and a wheel lift mechanism for changing movement direction and an enclosure which defines an enclosed first area for transporting a person within, the enclosure comprising a lockable barrier configured to provide access for a person into the first area, wherein the second area is partitioned from an operating area and comprises a lockable barrier configured to provide access for a person into the second area from the first area, the automated storage and retrieval system comprising a grid-based rail system and the method comprises the steps of using the control system to:
request to move the transport vehicle from a personnel transfer position next to the second area;
confirm that the lockable barrier of the transport vehicle is locked, and if the lockable barrier is not locked, abort and wait for confirmation that the lockable barrier is locked;
confirm that the lockable barrier of the second area is locked, and if the lockable barrier is not locked, abort and wait for confirmation that the lockable barrier is locked;
set the wheel lift mechanism to operation mode;
set the vehicle drive to operation mode; and
move away from the personnel transfer position.

47. The method according to claim 46, wherein the second area is a safe area for performing service on one or more container handling vehicles.

48. The method according to claim 46, wherein the second area is a second transport vehicle.

49. The method according to claim 46, further comprising lowering all wheels of a first set of wheels and a second set of wheels to the rail system when the transport vehicle is at the personnel transfer position.

50. The method according to claim 46, further comprising lowering a support into contact with the rail system when the transport vehicle is at the personnel transfer position.
